(19) United States
(12) Patent Application Publication
(10) Pub. No.: US 2010/0008849 A1
(43) Pub. Date: Jan. 14, 2010

(54) Method of generating hydrogen and of selectively transferring the generated hydrogen to drinking water as a potential source of alternative cellular energy (ACE)

(76) Inventor: William John Martin, South Pasadena, CA (US)

Correspondence Address: William John Martin, 1634 Spruce Street, South Pasadena, CA, 91030, US

(21) Appl. No.: 12/217,924

(22) Filed: Jul. 9, 2008

(51) Int. Cl. C01B 3/08

(52) U.S. Cl. 423/657

(57) ABSTRACT

Consuming water with increased hydrogen content can provide clinical benefits to humans and animals through a non-mitochondria alternative cellular energy (ACE) pathway and also as an antioxidant. This application discloses that the hydrogen content of drinking water can be safely increased by placing into the water a hydrogen generating device, such as a mixture of metallic magnesium and magnesium chloride containing solution, whereby the device allows for the selective passage of the generated hydrogen but restricts the passage of magnesium and magnesium ions. This partitioning of hydrogen from magnesium ions is achieved by using either reverse osmosis membrane or low density plastic material such as polyvinylidene chloride (PVDC or Saran), to create a sealed container of the magnesium and magnesium chloride, that can be placed into drinkable water. The magnesium chloride can be initially placed into a breakable inner compartment within the hydrogen permeable container. This compartment can be easily broken by simple squeezing just prior to placing the device into the water that is intended to have its hydrogen content increased. The increased hydrogen content can be assessed by the capacity of the water to decolorize a potassium permanganate test sample.

### CROSS REFERENCE TO RELATED APPLICATIONS

Co-Pending Patent Application

Methods for Detection of Ultraviolet Light Reactive Alternative Cellular Energy Pigments (ACE-pigments) William John Martin Submitted Dec. 24, 2007

Method of Activating the Alternative Cellular Energy (ACE) Pathway in the Therapy of Herpes Virus Infections William John Martin and Sheila Calderon Submitted Dec. 26, 2007

Method of Assessing and of Activating the Alternative Cellular Energy (ACE) Pathway in the Therapy of Diseases. William John Martin Submitted Jan. 17, 2008

Enerceutical Mediated Activation of the Alternative Cellular Energy (ACE) Pathway in the Therapy of Diseases William John Martin Submitted May 8, 2008

Previously Submitted but Now Abandoned Patent Applications

Ser. No. 10/044,683. Therapy of stealth virus associated cancers and other conditions using light. William John Martin. (Abandoned)

Ser. No. 10/047,313. Therapy of stealth virus associated cancers and other conditions using medium chain triglycerides. William John Martin. (Abandoned)

Ser. No. 10/050,232. Diagnosing and monitoring the therapy of stealth virus infections based on the detection of auto-fluorescent material in hair. William John Martin. (Abandoned)

Ser. No. 10/058,480. Therapy of stealth virus associated cancers and other conditions using magnetic energy. William John Martin. (Abandoned)

Ser. No. 10/164,258 Energy supportive therapy of stealth virus associated diseases. William John Martin. (Abandoned)

Ser. No. 10/174,466 Sound therapy of stealth virus associated diseases. William John Martin. (Abandoned)

Ser. No. 10/192,936 ACE-Pigments and humic acids as energy sources. William John Martin. (Abandoned)

Submitted: Ser. No. 10/ Methods for Collection of Alternative Cellular Energy Pigments (ACE-pigments). William John Martin. (Abandoned)

Submitted: Ser. No. 10/ Methods for Elimination of Toxic Alternative Cellular Energy Pigments (ACE-pigments) and for Their Replacement Using Activated Humates, including Humic and Fulvic Acids. William John Martin. (Abandoned)

United States Patents (Awarded)

U.S. Pat. No. 5,985,546 Stealth virus detection in the chronic fatigue syndrome. William John Martin

U.S. Pat. No. 5,891,468 Stealth virus detection in the chronic fatigue syndrome. William John Martin

U.S. Pat. No. 5,753,488 Isolated stealth viruses and related vaccines. William John Martin

U.S. Pat. No. 5,703,221 Stealth virus nucleic acids and related methods. William John Martin

PCT (Patent Cooperation Treaty)

WO 92/20797 Stealth virus detection in the chronic fatigue syndrome. William John Martin

WO 99/34019 Stealth virus nucleic acids and related methods. William John Martin

WO 99/60101 Stealth viruses and related vaccines. William John Martin

### REFERENCES TO PUBLISHED ARTICLES

Alternative Cellular Energy Pigments (ACE-pigments):
1. Martin W J. Alternative cellular energy pigments mistaken for parasitic skin infestations. Exp. Mol. Path 78: 212-214, 2005.
2. Martin W J. Alternative cellular energy pigments from bacteria of stealth virus infected individuals. Exp. Mol. Path 78: 217-217, 2005.
3. Martin W J. Progressive Medicine. Exp Mol Path 78: 218-220, 2005.
4. Martin W J, Stoneburner J. Symptomatic relief of herpetic skin lesions utilizing an energy based approach to healing. Exp. Mol. Path 78: 131-4, 2005.
5. Martin W J. Etheric Biology. Exp Mol Path 78: 221-227, 2005.
6. Martin W J. Stealth Virus Culture Pigments: A Potential Source of Cellular Energy. Exp. Mol. Pathol. 74: 210-223, 2003.
7. Martin W J. Complex intracellular inclusions in the brain of a child with a stealth virus encephalopathy. Exp. Mol. Pathol. 74: 179-209, 2003.
8. Martin W J. Photons and phonons: Theoretical aspects of biophysics and potential therapeutic applications. Proceeding of Neural Therapy Workshop on Sound and Light Therapy, Seattle, Wash., Feb. 21-23, 2003.

### STATEMENT REGARDING FEDERALLY SPONSORED RESEARCH OR DEVELOPMENT

Not applicable: No Federal funding was received in support of this patent application.

### REFERENCE TO SEQUENCE LISTING, A TABLE OR A COMPUTER PROGRAM LISTING COMPACT DISK APPENDIX

Not applicable.

### BACKGROUND OF THE INVENTION

The invention is based on the following broad conceptual understanding on how the body can acquire cellular energy other than through the oxidative metabolism of foods. Essentially, an alternative cellular energy (ACE) pathway has been identified that is mediated by the energy converting (transducing) properties of mineral containing complexes of organic molecules; arbitrarily termed alternative cellular energy pigments (ACE pigments) when derived from patients, and enerceuticals when derived from other sources. Cellular energy generated by this pathway can seemingly complement the chemical energy that is derived by living organisms from the metabolism of food. The ACE pathway is likely to contribute to various physiological functions of the body. Of particular relevance to public health programs, the ACE pathway is postulated to provide an auxiliary defense mechanism beyond that of the immunological system, such that an inadequacy of this pathway may limit the body's capacity to overcome various infectious diseases. The ACE pathway is also anticipated to be involved in the normal functioning of the brain since ACE pigments have been identified in brain tissue and appear to be transported within peripheral nerves. It is reasonable to presume that many illnesses, not necessarily of infectious origin, may place an added burden on the ACE pathway and that an inadequacy, deprivation or excessive demands on the ACE pathway may be a factor in delaying the normal disease recovery process. Conversely, augmentation or activation of an impaired ACE pathway may facilitate recovery from a wide range of illnesses. Moreover, a fully functioning ACE pathway is likely to be a factor in disease prevention, maintaining optimal wellness, enhancing athletic performance, increasing cognitive abilities, etc. The listed pending and awarded patents relating to the ACE pathway are incorporated herein by reference.

An important insight into the ACE pathway has come from observing reducing (electron donating) activity and gas bubble formation alongside ACE pigments suspended in water. A photograph showing gas formation was published in the article I wrote entitled “Alternative cellular energy pigments mistaken for parasitic skin infestations.” Exp. Mol. Path 78: 212-214, 2005. To experienced observers, the gas bubble shown in this paper has visual characteristics of hydrogen rather than oxygen. Note that hydrogen gas can form from molecular hydrogen, i.e., a hydrogen atom that retains its electron, or possibly even acquires a second electron (H⁻). Molecular hydrogen atoms can donate their electrons in reducing reactions and become H⁺ ions. Consistent with the concept that molecular hydrogen is directly involved in the ACE pathway is the additional finding of electron donating and occasional apparent hydrogen gas formation in various enerceutical products that can substitute for patient derived ACE pigments. I now believe that molecular hydrogen may, in fact, be part of the ACE pathway. Additional reasoning along these lines is as follows:

The energy embedded in photosynthesized compounds, such as carbohydrates, is mainly retrieved by eukaryotic cells through the process of oxidative phosphorylation occurring within mitochondria. This process comprises the formation of a hydrogen ion gradient that is used to drive the synthesis of adenosine triphosphate (ATP) via the enzyme ATP synthase. The hydrogen atoms derived from carbohydrates are captured and carried by nicotinamide adenine dinucleotide in the reaction “NAD⁺ plus 2H to yield NADH” which, in turn yields “NAD⁺ plus 2H⁺ plus 2 electrons (e⁻).” It is reasonable to suppose that prior to the availability of ATP synthase and NAD⁺ that the cell was able to directly use H atoms as an energy source.

Indeed in addition to published clinical studies, I have observed therapeutic benefits in patients consuming water with increased molecular hydrogen content. Other investigators have assumed that such benefits arises solely from antioxidant activity i.e. the capacity of molecular hydrogen to donate its electron to oxidizing toxic free radicals. To my knowledge, no other investigator has focused on the potential of hydrogen as a natural fuel source for the body. Whatever its mode of action, there is therapeutic value of water with an increased content of molecular hydrogen.

Hydrogen can be externally added to water, especially under pressure as a gas. More commonly, hydrogen is produced from the cathode in water electrolysis and in photoelectrolysis. Another approach has been to use magnesium particles mixed with ceramic particles and contained within a ceramic case. The water is said to be “pulverized by a discharge of electron and far-infrared ray effect of the ceramics.” This process may help activate the water and is also stated to result in hydrogen peroxide formation. (U.S. Pat. No. 7,189,330 Method of producing hydrogen rich water and hydrogen rich water generator)

Hydrogen production in water from magnesium is known to be greatly enhanced in the presence of hydrochloric acid. Less well known in the field of chemistry is that magnesium chloride can also markedly enhance the formation of hydrogen by metallic magnesium. To make clinical use of this knowledge, it is desirable to have a circumstance where the magnesium and the magnesium chloride can be maintained physically separable from any water that is intended for consumption. This can not be achieved with porous ceramic since the magnesium ions would readily diffuse into the water. Some form of partitioning is needed to allow the passage of hydrogen, yet to restrict the passage of magnesium and chloride ions. The present application discloses such a method.

It is also relevant to this application to note that magnesium chloride is the second most abundant salt in sea water (after sodium chloride). Historically, many health benefits have been ascribed to ingesting sea water (for example Renee Quinton in the early 1900's advocated sea water as medical therapy). For marketing purposes, he promoted the possibility that plankton was somewhat involved, but numerous farmers have confirmed the growth promoting benefits of plain sea water. Magnesium chloride is the main component of a therapeutic product derived from the water of the Great Salt Lake. The collected water is processed by partial evaporation, such that sodium chloride is removed by precipitation. This product is called Liquid Ionic Minerals and is marketed by Marine Minerals Inc. (www.marineminerals.com). Its use is limited by the unpleasant salty taste even at one drop per oz. Furthermore, consuming too much magnesium chloride can cause diarrhea and cardiac irregularities. Nevertheless, it has been argued, but largely neglected, that the direct ingestion and even transdermal use of magnesium chloride has healing properties for a variety of ailments. Another neglected observation was the reports of significant therapeutic benefit seen in humans upon administering a dilute solution of hydrochloric acid.

### BRIEF SUMMARY OF THE INVENTION

The invention describes a hydrogen generating mechanism that is coupled to a method of allowing the generated hydrogen to selectively pass into water that remains suitable for drinking. I initially confirmed the markedly enhanced production of hydrogen by simply placing small particles of metallic magnesium (hereinafter referred to as magnesium particles) into sea water, magnesium chloride solution and water from the Great Salt Lake. The formation of hydrogen gas bubbles easily exceeds by a factor of 10 that produced by magnesium particles alone, but was still less than half of that achievable using hydrochloric acid. Magnesium chloride, as well as hydrochloric acid also increased the availability of molecular hydrogen, as opposed to the chemically inert hydrogen gas that readily escapes from the water. This was shown by the capacity of the hydrogen enhanced water to rapidly decolorize a dilute solution of the oxidizing chemical, potassium permanganate (discussed below).

The actual role of the magnesium chloride is somewhat uncertain but presumably provides an energy stepping stone between magnesium and magnesium hydroxide in the reaction Mg+2H₂0→Mg(OH)₂+2H (Note 2H can, but does not necessarily form H₂ gas).

The next issue was to provide a method that allows hydrogen, which is generated in a reaction between magnesium particles and magnesium chloride, to freely pass into water that is suitable for drinking. Hydrogen atoms can penetrate various types of barriers that are impermeable to many other compounds. Permeability is mainly on the basis of the small size of the hydrogen atom. Magnesium and chloride ions are far larger than hydrogen and furthermore, they bond with water molecules as hydrated ions. It is possible, therefore, to obtain materials that will allow the passage of molecular hydrogen or hydrogen gas, but be impermeable to magnesium and chloride ions, as well as to magnesium particles. Potential materials include various metals, such as niobium, vanadium, tantalum or their alloys, but not, for example, aluminum (http://www.rebresearch.com/H2perm2.htm). More economical and more conveniently available are several low density plastics (organic polymeric materials). For example, hydrogen gas permeability has been reported for polychlorotrifluoroethylene (PCTFE or Aclar®), polychlorotrifluoroethylene copolyethylene (PCTFFJPE or Halar®) and polyvinylidene chloride (PVDC or Saran®). Another grouping of potential hydrogen permeable (magnesium and chloride ion impearmeable materials) are the membranes used for reverse osmosis of water. Reverse osmosis membrane, referred to hereinafter as R/O membrane, allows for the passage of water, which could potentially facilitate the transfer of dissolved molecular hydrogen atoms. R/O membranes vary in the amount of pressure needed to be applied to obtain optimal transfer of water. For the present studies Saran wrap and a low presure R/O membrane, were chosen to demonstrate the selective transfer of hydrogen, generated from the reaction of magnesium with magnesium chloride, into water that remains magnesium free and is suitable for consumption.

The presence of hydrogen reducing activity in water can be easily assessed by the capacity of the water to decolorize the redox sensitive chemical potassium permanganate. This chemical is purple/red in oxidizing solutions (positive redox values) and becomes colorless when present in water with a negative redox value. At neutral pH the transition is at a slightly positive redox value. The speed of decolorization is an approximate measure of the negativity (reducing or electron donating capacity) of water. The basic reaction is colored permanganate ions changing to colorless manganese oxide ions.

MnO₄⁻+2H₂O+3e⁻→MnO₂+4OH⁻, E⁰=0.59 V

Magnesium chloride can be purchased as either an anhydrous salt or as hydrated crystals. As noted above, magnesium chloride is the second major component in sea water and the major component in the liquid ionic product derived from the Great Salt Lake that is depleted of sodium chloride. Magnesium particles are obtainable as fine, irregularly shaped shavings from major metal suppliers. Magnesium powders can also be obtained. Saran wrap is made by Johnson and Johnson. Low pressure R/O membrane (ACM4) was obtained from a commercial supplier.

In one embodiment, the Saran wrap and the R/O membrane can be used in the form of a sealed tea bag like container that is simply placed into the water that is intended to be consumed. Since in the preferred embodiment, the magnesium chloride/sea water is in a liquid form, it can be kept separated from the magnesium particles before use by simply placing the liquid within an easily breakable pouch within the tea bag like structure.

Using this type of device, it was possible to provide hydrogen enhanced water that readily decolorized potassium permanganate, was unaltered in its pH and was devoid of any testable magnesium chloride.

### BRIEF DESCRIPTION OF THE DRAWINGS

Not Applicable and none included

### DETAILED DESCRIPTION OF THE INVENTION

In a specific embodiment, both low pressure R/O membrane (ACM4), and Saran wrap were folded into a tubular shape containers and the bottom opening and the side edges tightly sealed with adhesive tape, leaving a small opening at the top. Approximately 1 gram of magnesium particles was introduced into the column space surrounded by either the R/O membrane or Saran wrap. The inner space was then filled with 1 ml of either of the following: i) magnesium chloride solution (dissolved crystals from Fisher Scientific Company, Cat. M-33); ii) sea water; or iii) Liquid Ionic Minerals obtained from sodium chloride depleted water from the Great Salt Lake (Marine Minerals). Any residual air was removed by gently squeezing the membrane and the remaining opening on the constructed bag was folded and tightly sealed. Note heat can also be used for sealing the ends and sides of the constructed containers. Care was taken not to allow any tears in the Saran wrap from the magnesium shavings, a problem less likely to be encountered using magnesium powder.

Individual membrane bags were placed in jars filled with approximately 100 ml of regular tap water. A lid was placed onto each of the jars. Control jars contained either tap water alone or tap water to which empty Saran wrap or R/O membrane bags, or bags containing either magnesium particles or magnesium chloride, but not both, were added. At differing times, water samples were removed from the jars and added to equal volumes of a discernibly red solution of potassium permanganate. Easily observed decolorizing capacity of the tap water in contact with the Saran wrap and the R/O membrane bags that contained both magnesium particles and a source of magnesium chloride, developed within a ten minutes of placing the bag into the tap water. This capacity increased over the next 30 minutes, during which time actual gas bubbles (presumably hydrogen) appeared within the test jars, especially those with the Saran wrap. The pH of all of the water samples remained essentially unchanged at around 6.5.

Water samples were also tasted to determine if any magnesium chloride had penetrated the bag and entered into the water. No hint of any magnesium chloride being present was obtained. As a final demonstration, drops of a concentrated solution of potassium permanganate solution were added to the water in the various jars. Water in all of the test jars, but not the control jars, immediately decolorized the added drops of potassium permanganate. In the control jars, the drops could still be seen for several minutes as they slowly mixed with the water leading to an overall pinkish color of the water in these jars.

The above experiments confirmed the use of magnesium in the presence of magnesium chloride to generate hydrogen and for the ability of the hydrogen to be delivered to drinkable water in the absence of any transfer of appreciable amounts of magnesium chloride by using containers made from Saran wrap or R/O membrane, This method achieves the purpose of providing a simple method for enriching water with hydrogen. Such water is believed to assist in enhancing the ACE pathway for the therapy of diseases, and for the promotion of overall vitality in humans as well as potentially in animals.

An alternative method of generating hydrogen from water using magnesium is to react the magnesium with hydrochloric acid. Hydrogen ions from the hydrochloric acid could potentially be prevented from entering the water if a barrier method existed that would exclude H⁺ ions but allow the free passage of molecular hydrogen. Neither the Saran wrap nor the R/O membrane can provide such a barrier and the use of hydrochloric acid in the present system would raise regulatory issues relating to modifying the pH of the water to be consumed. The current invention using magnesium and magnesium chloride allows for nothing other than the newly generated hydrogen to enter into the drinkable water.

The principles, preferred embodiments and modes of operation of the present invention have been described in the foregoing specification. The invention which is intended to be protected herein, however, is not to be construed as limited to the sole use of Saran wrap or R/O membrane as the method for allowing selective passage of the generated hydrogen into water. Many other membranes will be found to be suitable for this purpose. Nor is the method restricted to only using magnesium plus magnesium chloride as the means of generating hydrogen. Various alloys of magnesium can show similar hydrogen producing activity as magnesium as can other alloys of various minerals, e.g. certain alloys of aluminum. The combination of magnesium and magnesium chloride containing solutions is particularly attractive, however, since it extends and helps explain earlier clinical observations regarding the health benefits of magnesium chloride, and possibly also of hydrochloric acid.

Additional embodiments and modifications will readily occur to those skilled in the art and especially upon practicing the currently described methods. Variations and changes may be made without departing from the spirit of the invention encompassed by the appended claims.

What I claim as my invention is:

1. A method for increasing the hydrogen content of water by reacting magnesium particles with a magnesium chloride solution within a closed container that is placed into the water; the said container comprising a material that allows for the selective passage of hydrogen into the water, while preventing magnesium or other soluble ions present within the container from entering into the water.

2. The method of claim 1 in which the container is constructed from a membrane suitable for the reverse osmosis of water because of its ability to block the passage of ions such as magnesium and chloride while allowing for the passage of hydrogen.

3. The method of claim 1 in which the container is constructed from a low density plastic membrane, such as polyvinylidene chloride (PVDC or Saran wrap) that has the ability to block the passage of ions such as magnesium and chloride while allowing for the passage of hydrogen.

4. The method of claim 1 in which the magnesium chloride is a purified or partially purified chemical reagent.

5. The method of claim 1 in which the magnesium chloride solution is sea water or a derivative of sea water.

6. The method of claim 1 in which the magnesium chloride solution is present within water from an inland source or in a derivative of an inland water source.

7. The method of claim 1 in which the magnesium chloride is packaged into a breakable inner compartment within the hydrogen permeable container, such that the inner compartment maintains separation of the magnesium chloride from the magnesium particles until the inner compartment is broken by squeezing, which is performed just prior to placing the hydrogen permeable container in water.

8. The method of claim 1 in which the magnesium particles are in the form of metal shavings

9. The method of claim 1 in which the magnesium particles are in the form of a metallic powder.
